(19) United States
(12) Patent Application Publication
(10) Pub. No.: US 2004/0259586 A1
(43) Pub. Date: Dec. 23, 2004

(54) Method of changing emitting light of a mobile phone

(76) Inventor: Cheng-Wen Huang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/462,686

(22) Filed: Jun. 17, 2003

(51) Int. Cl. H04M 1/00; H04B 1/38

(52) U.S. Cl. 455/550.1; 455/566

(57) ABSTRACT

A method of changing light emitted from a mobile phone. The mobile phone includes a circuit board, a plurality of buttons set on the circuit board forming a button area on the mobile phone, and a plurality of light sources set on the circuit board. The method includes providing a casing, adding fluorescent material onto the casing, positioning the casing with the fluorescent material on a side of the circuit board with the plurality of light sources, and triggering the plurality of light sources such that light passing through the casing is different from backlight originally emitted from the plurality of light sources.

### BACKGROUND OF INVENTION

1. Field of the Invention

The present invention relates to a method used in a mobile phone, more specifically, a method for changing the emitting light color while the light sources of the mobile phone are triggered.

2. Description of the Prior Art

Owing to the rapid development of wireless communication systems, people can access resources, exchange information, and share experiences via a mobile phone or other wireless communication devices anytime and anywhere. The buttons of the mobile phone are used to be an input interface. The finite buttons on the mobile phone generally includes the numeral 0-9 buttons, the “*” button, the “#” button, and so on. However, a mark on each button for representing function of the button, due to its small size, is hard to recognize in the dark with the naked eye.

In order to identify the buttons when using the mobile phone in the dark or at night more easily, the existing mobile phone has light emitting diodes (LEDs) as light sources under the buttons. In general, the number of LEDs is 6 or 8. The LEDs emit light to illuminate the buttons, while the mobile phone 10 is receiving message, being called by someone, or when any of the buttons 14 are being pressed. The LEDs are turned off to save power when the mobile phone 10 is in standby mode. But the emitted light of the LEDs is a single color, and is very boring for present capricious users. If intending to change the light color of the mobile phone 10, replacing the LED is required, for example, replacing the original white LEDs to red, green, blue LEDs and so on. However, replacing LEDs are required extra time and cost, and is inconvenient for the user.

### SUMMARY OF INVENTION

It is therefore a general objective of the claimed invention to provide a method used in a mobile phone for changing the emitting light color of a mobile phone while the light sources is emitting light, to solve the aforementioned problem.

Briefly summarized, the claimed invention provides a method of changing light emitted from a mobile phone. The mobile phone includes a circuit board, a plurality of buttons set on the circuit board forming a button area on the mobile phone, and a plurality of light sources set on the circuit board. The method includes providing a casing, adding fluorescent material onto the casing, positioning the casing with the fluorescent material on a side of the circuit board with the plurality of light sources, and triggering the plurality of light sources such that light passing through the casing is different from backlight originally emitted from the plurality of light sources.

The claimed invention also provides a method of changing light emitted from a mobile phone. The mobile phone comprises a casing, a circuit board, a plurality of buttons set on the circuit board forming a button area on the mobile phone, and a plurality of light sources set on the circuit board. The method comprises the steps of providing a film, painting fluorescent material onto the film, sticking the film onto the casing, positioning the casing on a side of the circuit board with the plurality of light sources, and triggering the plurality of light sources such that light passing through the casing is different from backlight originally emitted from the plurality of light sources.

These and other objectives of the claimed invention will no doubt become obvious to those of ordinary skill in the art after reading the following detailed description of the invention, which is illustrated in the various figures and drawings.

### BRIEF DESCRIPTION OF DRAWINGS

FIG. 1 is a schematic diagram of a mobile phone according to the present invention.

FIG. 2 is an exploded diagram of the mobile phone.

FIG. 3 is a flowchart of changing the light color emitted by the mobile phone.

FIG. 4 shows an exploded diagram of another embodiment of a mobile phone according to the present invention.

FIG. 5 is flowchart of another embodiment of changing the light color emitted by the mobile phone depicted in FIG. 4.

### DETAILED DESCRIPTION

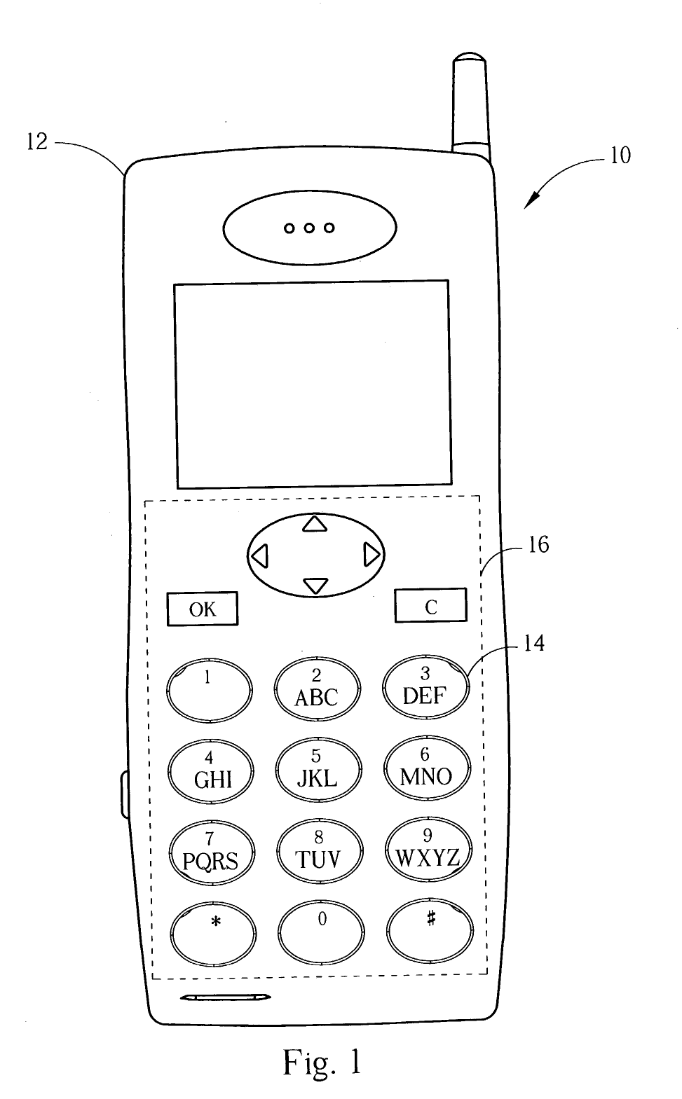

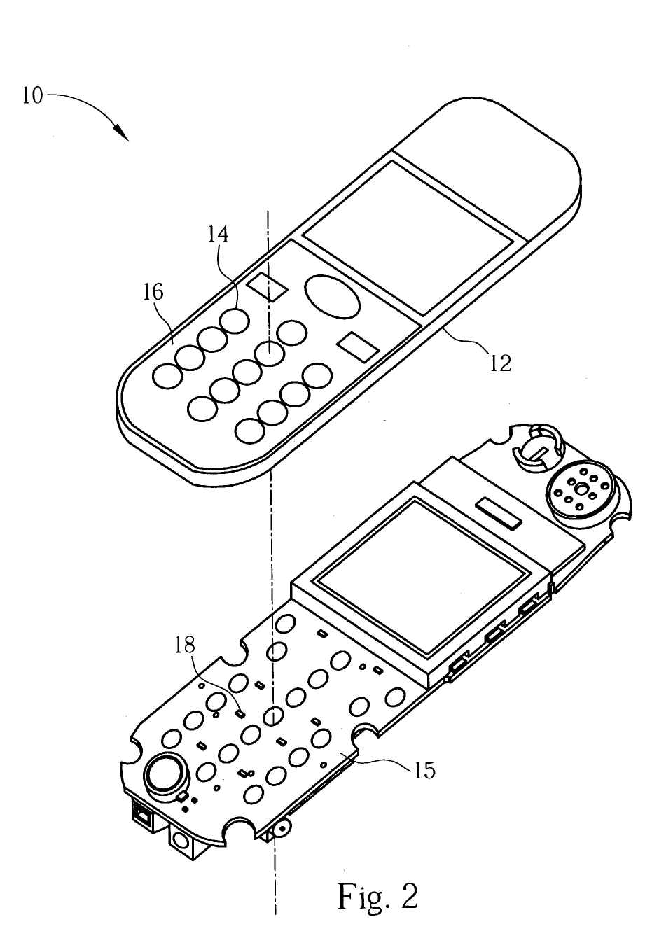

Please refer to FIG. 1 and FIG. 2. FIG. 1 shows a schematic diagram of a mobile phone 10 according to the present invention. FIG. 2 shows an exploded diagram of the mobile phone 10. The mobile phone 10 comprises a casing 12, a plurality of buttons 14, a circuit board 15 and a plurality of light sources 18. The plurality of light sources 18, which can be light emitting diodes (LEDs), are installed on the circuit board 15 to form a button area 16. When any of the plurality of buttons 14 is triggered, the plurality of the light sources 18 generates backlight to illuminate the button area 16. The plurality of the light sources 18 can illuminate different backlight depending on what LEDs are chosen.

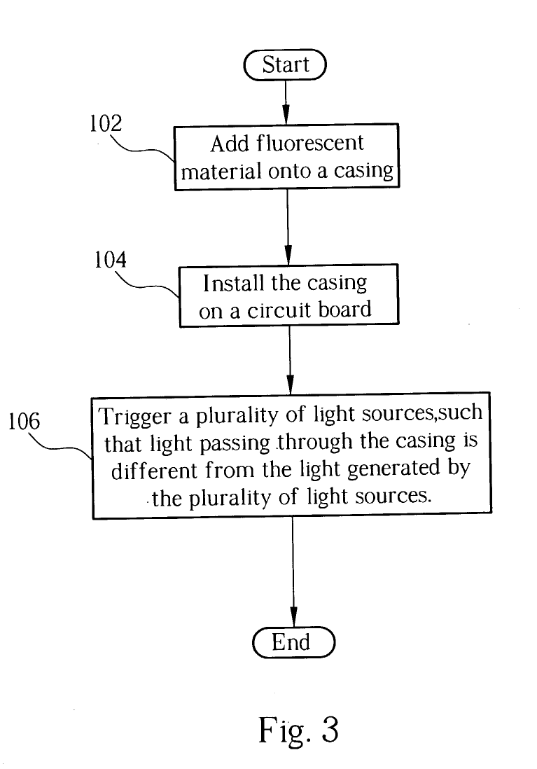

Please refer to FIG. 3, which is a flowchart of changing the light color emitted by the mobile phone 10.

Step 102: add fluorescent material onto the casing 12;

Step 104: install the casing 12 with the fluorescent material on a side of the circuit board 15 with the plurality of light sources 18; and

Step 106: trigger any of the plurality of light sources 18, such that light passing through the casing 12 is different from the light generated by the plurality of light sources 18.

In a manufacturing procedure, the casing 12 can be painted with photo excitation fluorescent material with various colors such as red, blue, green, and so on (step 102). Afterwards, the casing 12 with the fluorescent material is installed on the side of the circuit board 15, where the plurality of light sources 18 are set (step 104). Suppose that the plurality of the light sources 18 are white-light LEDs, if the user hopes the. light of the mobile phone 10 he sees is red, the casing 12 added with red fluorescent material can be chosen for assembly onto the circuit board 15. In this way, once the plurality of light sources 18 emit white light due to message-receiving, someone-calling, or any of the buttons 14 being pressed, the user, however, will see red light, instead of white light originally emitted from the plurality of light sources 18, when the white light emitted by the plurality of light sources 18 passes through the casing 12 with red fluorescent material. If the user desires to see blue light, the casing 12 with blue fluorescent material is chosen to install on the circuit board 15, preventing form wasting time to replace the plurality of light sources 18 by blue LEDs.

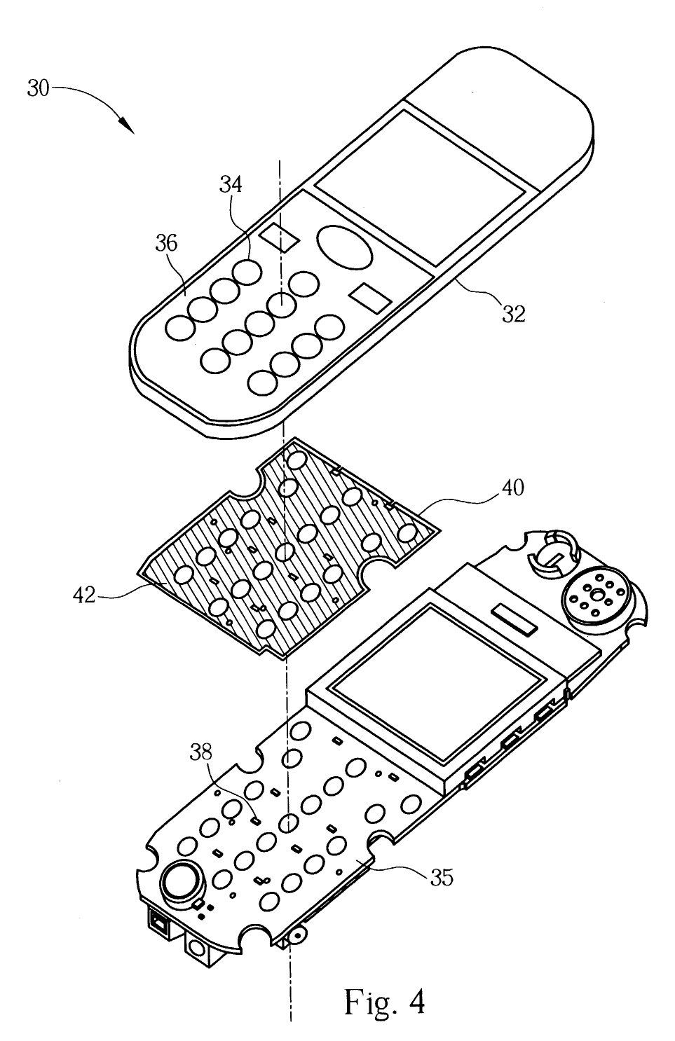

Please refer to FIG. 4. FIG. 4 shows an exploded diagram of another embodiment of a mobile phone 30 according to the present invention. The mobile phone 30 comprises a casing 32, a plurality of buttons 34, a circuit board 35, a plurality of light sources 38 and a film 40. The plurality of light sources 38, which can be light emitting diodes (LEDs), are installed on the circuit board 35 to form a button area 36. When any of the plurality of buttons 34 is triggered, the plurality of the light sources 38 generates backlight to illuminate the button area 36. The plurality of the light sources 38 can illuminate different backlight depending on what LEDs are chosen. The film 40 can be a myler.

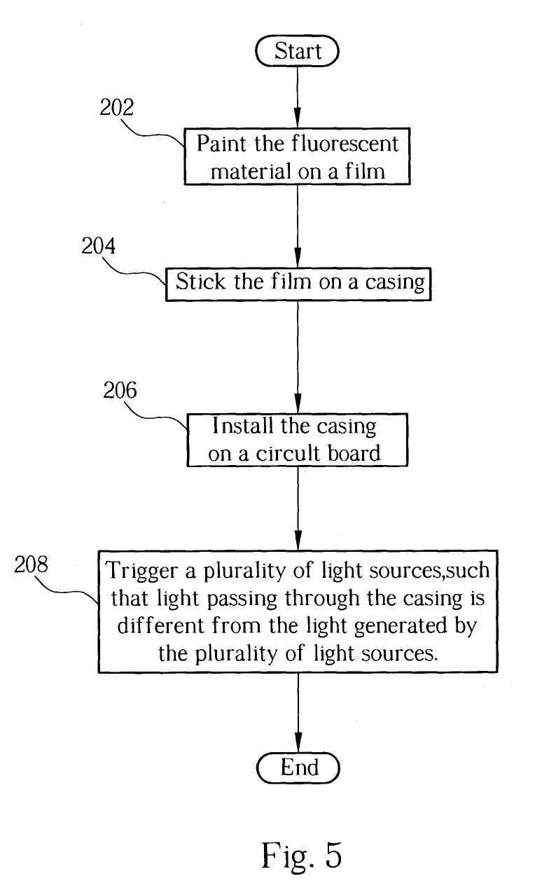

Please refer to FIG. 5, which shows a flowchart of changing the light color emitted by the mobile phone 30 depicted in FIG. 4.

Step 202:paint the fluorescent material on the film 40;

Step 204: stick the film 40 onto the casing 32;

Step 206: install the casing 32 on a side of the circuit board 35 with the plurality of light sources 38;

Step 208: trigger any of the plurality of light sources 38, such that light passing through the casing 32 is different from the light generating by the plurality of light sources 38.

The film 40 can be painted photo excitation fluorescent material 42 with various color such as red, blue, green, and so on (step 202). Afterwards, the user can stick the film 40 with the fluorescent material to the casing 12 depending on his demand (step 204). Suppose that the plurality of the light sources 38 are white-light LEDs, if the user hopes the light of the mobile phone 10 he sees is red, the film with red fluorescent material is suitable to stick to the casing 12. Then, the casing 32 with the selected film 40 can be installed on the side of the circuit board 35, where the plurality of light sources 38 are set (step 206). In this way, once the plurality of light sources 38, due to message-receiving, someone-calling or any of the buttons 34 being pressed, are emitting white light, the user, however, will see red light, instead of white light originally emitted from the plurality of light sources 38, since the white light emitted by the plurality of light sources 38 passes through the film 40 with red fluorescent material. If the user desires to see blue light, the film 40 with blue fluorescent material can be chosen to install on the circuit board 35, preventing from wasting time to replace the plurality of light sources 38 by blue LEDs.

In contrast to prior art, the light color emitted by the mobile phone using the present invention method can be changed by changing the casing or the film, without changing LEDs with spending extra money and time any more. This is a time-saving and money-saving method.

Those skilled in the art will readily observe that numerous modifications and alterations of the method may be made while retaining the teachings of the invention. Accordingly, the above disclosure should be construed as limited only by the metes and bounds of the appended claims.

What is claimed is:

1. A method of changing light emitted from a mobile phone, the mobile phone comprising a circuit board, a plurality of buttons set on the circuit board forming a button area on the mobile phone, and a plurality of light sources set on the circuit board; the method comprising:
providing a casing;
adding fluorescent material onto the casing;
positioning the casing with the fluorescent material on a side of the circuit board with the plurality of light sources; and
triggering the plurality of light sources such that light passing through the casing is different from backlight originally emitted from the plurality of light sources.

2. The method of claim 1 wherein the plurality of light sources are light emitting diodes (LEDs).

3. A method of changing light emitted from a mobile phone, the mobile phone comprising a casing, a circuit board, a plurality of buttons set on the circuit board forming a button area on the mobile phone, and a plurality of light sources set on the circuit board; the method comprising:
providing a film;
painting fluorescent material onto the film;
sticking the film onto the casing;
positioning the casing on a side of the circuit board with the plurality of light sources; and
triggering the plurality of light sources such that light passing through the casing is different from backlight originally emitted from the plurality of light sources.

4. The method of claim 3 wherein the film is a myler.

5. The method of claim 3 wherein the plurality of light sources are light emitting diodes (LEDs).
